(19) United States
(12) Patent Application Publication
(10) Pub. No.: US 2026/0257448 A1
(43) Pub. Date: Sep. 3, 2026

(54) APPARATUS FOR PROCESSING PREDOMINANTLY RIGID MATERIAL SHEETS OR MATERIAL WEBS, AND METHOD FOR CHANGING THE CONFIGURATION OF SUCH AN APPARATUS

(71) Applicant: Kolbus Group GmbH, Rahden (DE)

(72) Inventors: Vanessa Gruner, Leipzig (DE); Randolf Voigtländer, Colditz (DE)

(21) Appl. No.: 19/164,997

(22) PCT Filed: Dec. 18, 2023
(86) PCT No.: PCT/EP2023/086464

§ 371 Date: Sep. 12, 2025

(30) Foreign Application Priority Data
Mar. 13, 2023 (DE) 10 2023 106 199.2

(51) Int. Cl. B31F 1/10; B26D 3/06; B26D 3/08; B26D 5/06; B26D 5/08; B26D 5/26

(52) U.S. Cl. CPC B31F 1/10; B26D 3/065; B26D 3/085; B26D 5/06; B26D 5/083; B26D 5/26

(57) ABSTRACT

An apparatus for processing predominantly rigid sheets or webs, in particular of corrugated board, has a plurality of processing devices which are movable transversely with respect to a transport direction of the sheets or webs and which have different tools in variable arrangements. A plurality of such apparatuses are combined in a modifiable sequence to give a converting machine.

### BACKGROUND

The present invention relates to an apparatus for processing predominantly rigid material sheets or material webs according to the preamble of claim 1 and to a method for changing the configuration of a converting machine for corrugated board sheets or corrugated board webs according to the preamble of claim 12.

Converting machines that can carry out different processing steps such as printing, cutting, embossing, scoring, punching, perforating, gluing and/or stitching are known for processing rigid sheets or webs, particularly sheets or webs of corrugated board. Sheets are frequently processed and cut to size in processing machines with form-bound punching and cutting devices. For this purpose, multiple processing stations are arranged successively in a transport direction of the sheets.

WO2021094096A1 discloses a converting machine with a sheet feeder and multiple devices of different types, which are arranged behind one another. One processing step is carried out per segment. For this purpose, machines of this type are configured in accordance with the products to be manufactured. However, it is not possible to manufacture products that require a different process sequence or different types of processes at a later point in time. In some instances, the machine could be elaborately modified, but this solution is not economical.

### SUMMARY

The present invention therefore is based on the objective of creating an apparatus and a method that are improved in comparison with the prior art, eliminate at least one of the described disadvantages of the prior art and satisfy the increased requirements regarding versatility while achieving at least the same product quality.

This objective is attained with an apparatus according to claim 1 and a method according to claim 12.

For this purpose, an apparatus is provided, through which the material to be processed is transported in a linear movement. In this case, all positions assumed by the sheet or the web collectively form the transport path.

The individual components of the apparatus are accommodated in a common frame. The frame is formed by vertical supports that are connected by one or more horizontal crossbeams. The supports may be columns or walls. They are arranged opposite of one another to both sides of the transport path such that the sheet is transported between them.

Processing devices are arranged in the frame. These processing devices act upon the sheet or the web. For this purpose, the material may be at a standstill or processing may take place during a continuous transport movement. Processing operations that take place at a standstill, as well as during a movement of the material sheet, are not excluded.

Several of the processing devices are accommodated in the frame by means of a common linear guide. The linear guide is oriented transverse to the transport direction in such a way that the processing devices can be moved over the width of the transport path.

These processing devices respectively have one or more actuators. The actuators may be different types of actuators. They are connected to an electronic control of the apparatus for data transmission purposes. A high flexibility of the apparatus therefore is achieved with a compact constructive design. The apparatus particularly can be adjusted to different products to be processed or manufactured in an automated or at least semi-automated manner.

In a further development, the processing devices mounted by means of the linear guide respectively have a separate adjustment device. Each of these adjustment devices is designed in such a way that it can position the respectively assigned processing device along the linear guide or transverse to the transport direction of the sheet or web, respectively. For this purpose, each of these adjustment devices comprises a controllable adjustment drive. The adjustment drives are respectively connected to the control of the apparatus for data transmission purposes. At least one actuator of the processing device is formed by the adjustment drive.

A gear rack extending parallel to the linear guide is advantageously provided. This gear rack is arranged on a crossbeam of the frame. Gear wheels of several of the adjustment devices engage into the same gear rack. The gear wheels are respectively driven by the adjustment drive of the corresponding adjustment device. This makes it possible to achieve a simple and compact constructive design.

A transport device with a controllable drive preferably is accommodated in the frame. The transport device moves the material to be processed along the processing devices of the apparatus in the transport direction. The transport device advantageously comprises a detection device. This detection device is directed at the transport path. It detects the point in time, at which the material reaches a certain position. Alternatively, it detects the position that the material reaches at a certain point in time.

The acquired data is transmitted to the control of the apparatus. It is used for controlling or regulating different actuators of the apparatus, particularly of the transport drive. In this way, a very high positioning accuracy of processing operations can be achieved in the transport direction. This is particularly advantageous when apparatuses with this constructive design are arranged successively.

The processing devices accommodated on a common linear guide may be different types of processing devices. In this way, a very compact apparatus with high functional density can be realized.

The data exchange of the actuators and sensors with the control takes place in a tethered manner. The cables are provided with plug connectors in order to allow the removal or addition of devices of the apparatus with little effort.

As an alternative to cables, the data exchange may take place via radio or other wireless connections. This makes it possible to reduce the number of cables to be separated during the removal of processing devices or to be connected during the addition of processing devices.

In an advantageous embodiment, the apparatus has a loading position for the processing devices mounted by means of a common linear guide. This loading position is defined by a segment of the linear guide. This segment is accommodated in the frame in a plug-in manner. In order to remove a processing device, the respective processing device is positioned on this segment and removed from the apparatus together therewith. This significantly simplifies an exchange of processing devices and improves the flexibility of the apparatus.

It is particularly advantageous to assemble a plurality of such apparatuses so as to form a converting machine, particularly for processing corrugated board. For this purpose, the apparatuses are arranged behind one another in the transport direction in such a way that they collectively form a straight transport path.

It is advantageous that one of the apparatuses is movable along the transport direction in such a way that a gap can be formed between two apparatuses of the same machine, which are arranged in direct succession. This significantly improves the accessibility of the individual devices, e.g. for maintenance purposes.

For this purpose, it is preferred to provide a rail system, on which the apparatuses are collectively accommodated. The rails extend parallel to the transport direction. In this way, the respective position and alignment of the corresponding apparatuses is defined with the exception of the position in the transport direction. This means that the position of the interfaces between the individual apparatuses is reproducible without additional effort.

In another embodiment, a processing device in the form of a dispensing device is accommodated in a first apparatus such that it can be positioned transverse to the transport direction. For example, the dispensing device may be a device for applying glue or a printing unit, particularly an inkjet printing unit. Any second apparatus that follows this first apparatus in the transport direction comprises one or more second processing devices that can be positioned transverse to the transport direction. These second processing devices are in contact with the material to be processed during processing. The second processing devices particularly comprise at least one transport roller.

It is particularly advantageous to provide data links between the positioning drive of the dispensing device of one apparatus, as well as the positioning drives of the following second processing devices of another apparatus, and the same control of the converting machine. This makes it possible to position the contact area of the second processing devices with the sheet or the web outside the material applied by the dispensing device in a simple and automated manner.

In a particularly advantageous embodiment, the apparatuses that collectively form a converting machine, particularly the apparatus enclosed between terminal apparatuses, have identical interfaces. In this way, the sequence of the apparatuses can be easily adapted to different preferred sequences of processing steps.

### BRIEF DESCRIPTION OF THE DRAWINGS

An exemplary embodiment of the invention is described below with reference to the figures, to which we refer with respect to all details that are not explicitly mentioned in the description. In these figures:

FIG. 1 shows a first perspective view of an apparatus for sheet processing;

FIG. 2 shows a perspective view of a scoring device;

FIG. 3 shows a second perspective view of an apparatus for sheet processing; and

FIG. 4 shows a converting machine with multiple apparatuses for sheet processing.

### DETAILED DESCRIPTION

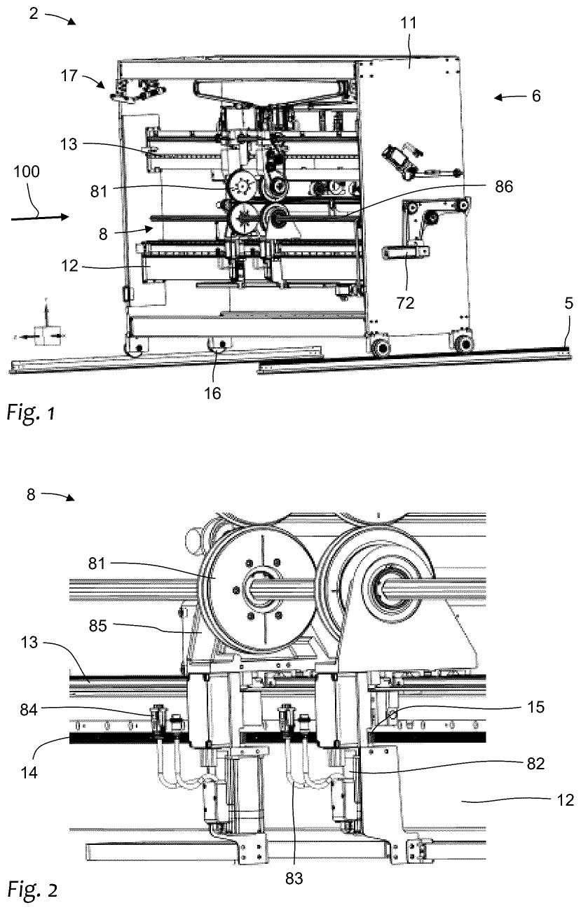

FIG. 1 and FIG. 2 show an apparatus 2 for processing sheets 30 or webs. The apparatus has a frame 6, in which all other devices 7, 8, 9 are accommodated. The material 30 to be processed is transported through the frame 6 in a straight line along a horizontal transport direction 100. The material 30 describes a transport path 130 as it moves through the apparatus 2.

The frame 6 consists of two vertical walls 11 that are arranged opposite of one another to both sides of the transport path 130. The walls 11 are connected by means of horizontal crossbeams 12. The crossbeams 12 extend transverse to the transport direction 100.

Guide rails 13 of linear guides are arranged on the crossbeams 12. Gear racks 14 are likewise arranged on the crossbeams. The gear racks 14 extend parallel to the linear guides 13. They are collectively aligned transverse to the transport direction 100. Processing devices 8, 9 are arranged on the linear guides 13 and can be respectively moved or positioned over the width of the sheets 30 or webs to be processed with the aid of the gear racks 14.

A transport device 7 is likewise accommodated in the frame 6. This transport device comprises a transport roller 71 arranged between the walls 11. The transport roller is located directly underneath the transport path 130. The region of the roller 71 effecting the transport extends over the maximum permissible width of the material 30 to be processed.

The transport device 7 comprises multiple transport rollers 76 that are arranged above the transport roller 71 and distributed over the width of the transport path 130. They collectively clamp the sheet 30 or the web. These transport rollers 76 are respectively arranged on one of the guide rails 13 so as to be separately movable transverse to the transport direction 100. They are individually positioned by means of a common adjustment device 77. The adjustment device utilizes the gear rack assigned to the linear guide.

The transport device 7 is equipped with a controllable drive 72. A light barrier 74 illustrated in FIG. 4 is arranged above the transport path 130. It detects the point in time, at which a sheet 30 reaches and leaves the monitored position in the transport direction 100. In this way, the transport can be controlled and processing operations can be precisely positioned in the transport direction.

The frame is equipped with rolls 16 that are arranged on the walls 11. These rolls run on a pair of rails 5 that extend parallel to the transport direction 100. In this way, the entire apparatus 2 can be moved in the transport direction 100. This movement can be carried out manually by the operating personnel or another adjustment device, which is not illustrated in the figures, can be used for this purpose.

FIG. 4 shows a converting machine for corrugated board sheets 30, wherein said converting machine is composed of multiple apparatuses 2, 3, 4 of the above-described design. These apparatuses 2, 3, 4 run on a common rail pair. Another apparatus 1 is provided on the end of the converting machine, wherein this terminal apparatus is stationary and accommodates a control 10 of the machine.

The individual apparatuses 1, 2, 3, 4 differ with respect to their processing devices 8, 9, 21. In the exemplary configuration illustrated in FIG. 4, a printing unit is installed in the first apparatus 4 viewed in the transport direction 100. In contrast, scoring devices 8 and scribing devices 9 are arranged in an apparatus 2 illustrated with broken lines. Additional processing devices of different types, which are not described in greater detail, are accommodated in the remaining apparatuses 1, 3.

FIG. 2 shows an enlarged detail of the scoring devices 8 illustrated in FIG. 1. They are designed mirror-inverted to one another. Consequently, the further description is limited to only one of the two scoring devices 8.

The scoring tool is composed of a pair of scoring knives 81 that form a male and a female die. The scoring knives 81 are arranged above and underneath the transport path 130 and interact with one another. Each scoring knife 81 is accommodated in a carriage 85. The carriages 85 run transverse to the transport direction 100 on the above-described rails 13 of the frame 6. The drive of the scoring knives 81 is realized with a noncircular shaft that is rigidly mounted in the frame by means of a sliding seat.

An adjustment device with a controllable adjustment drive 82 is arranged on the carriage 85 in order to position the scoring device 8. The adjustment drive acts upon the gear rack 14 arranged on the crossbeam 12 of the frame 6 by means of a gear wheel 15. The adjustment drive 82 is connected to the control 10 by means of data lines 83 with plug connectors 84.

Scribing devices 9 of the same design are provided behind the scoring device 8 viewed in the transport direction 100. Similar to the scoring device 8, a circular knife 91 of the scribing device 9 is accommodated in a carriage. The carriage once again runs on a rail 13 of the frame 6, which is oriented transverse to the transport direction 100. Contrary to the scoring tools 81, the scribing knife 91 is not equipped with its own drive.

The carriage with the scribing knife 91 is positioned along its guide rail 13 by means of a controllable adjustment device 93. For this purpose, it has a gear wheel that engages into a gear rack rigidly mounted in the frame and is driven by a controllable motor.

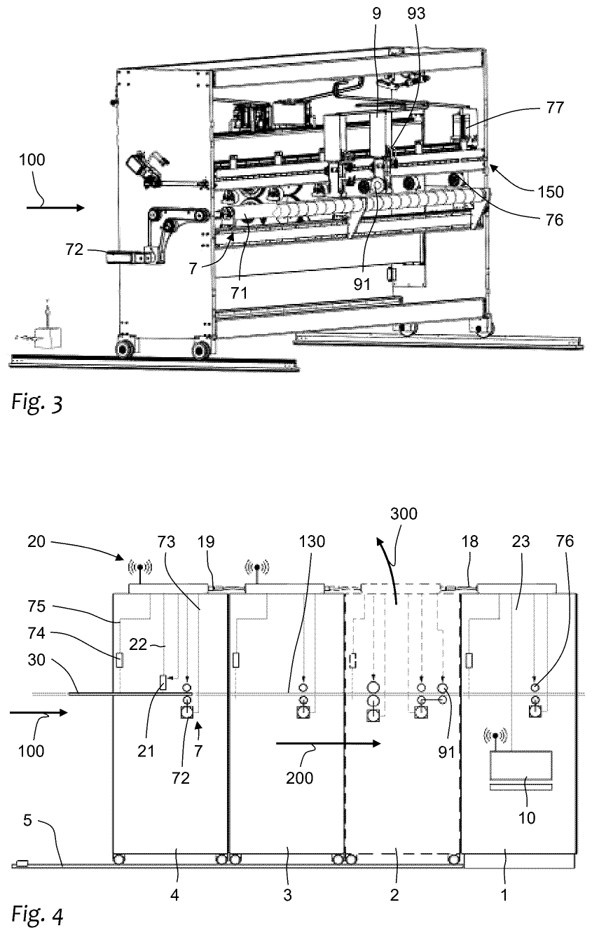

FIG. 3 shows a loading position 150 for devices that can be moved transverse to the transport direction, e.g. the scribing devices 9. The loading position 150 is defined by a segment of the described guide rail 13. This segment is removable. In order to remove a processing device 9, it is moved onto the removable segment and removed together with this segment. The addition of a processing device 9 takes place accordingly.

A print head 21 arranged in the apparatus 4 above the transport path 130 prints the upper side of the transported sheet 30. It can be moved transverse to the transport direction 100 by means of a not-shown adjustment device.

The control of the adjusting movements transverse to the transport direction 100 is indicated in FIG. 4 with arrows that the point at the tools 21, 76, 81, 91. The adjusting movements may take place while the machine is at a standstill or during the continuous transport movement of the sheet 30.

The data transmission between the individual apparatuses 1, 2, 3, 4, as well as their devices 7, 8, 9, 21, and the control 10 of the converting machine takes place via cables 18 that are provided with plug connectors 19 and extend between the individual apparatuses. It would alternatively also be possible to utilize a radio link, wherein a transmitting and receiving unit 20 is installed in each of the apparatuses in this case.

The dashed illustration of an apparatus 2 in FIG. 4 indicates that this apparatus does not necessarily have to be present in the converting machine shown or in the position shown. In fact, the configuration of different apparatuses 1, 2, 3, 4 that collectively form a converting machine can be easily changed.

The pair of rails 5 is provided for this purpose, wherein three apparatuses 2, 3, 4 of the four apparatuses 1, 2, 3, 4 illustrated in FIG. 4 can be displaced parallel to the transport direction 100 on these rails.

In order to change the configuration of the converting machine, the plug connections 84 of the involved apparatuses 1, 2, 3 are initially separated. This step can be eliminated in an alternative data transmission via radio. The mechanical interlocks 17 between the apparatuses 1, 2, 3 are likewise released.

Subsequently, the apparatuses 2, 3, 4 are positioned at a distance from one another on the rails 5 in such a way that an apparatus 2 can be removed without the risk of damages. The removal of the apparatus 2 is symbolized by the arrow 300 in FIG. 4.

Another not-shown apparatus may be alternatively or additionally provided. After moving together 200 the individual apparatuses 1, 2, 3, 4, the interlocks 17 are closed in order to secure the movable apparatuses 2, 3, 4 against inadvertent movements. The converting machine can be operated in its new configuration after the involved plugs 84 are connected or the radio links are initiated.

### REFERENCE SYMBOLS

1 First apparatus
2 Second apparatus
3 Third apparatus
4 Fourth apparatus
5 Rail
6 Frame
7 Transport device
8 Scoring device
9 Slitting device
10 Control
11 Wall
12 Crossbeam
13 Rail
14 Gear rack
15 Gear wheel
16 Roll
17 Interlock
18 Data line
19 Plug
20 Transmitter/receiver
21 Print head
22 Data line
23 Data line
30 Corrugated board sheet
71 Roller
72 Controllable drive
73 Data line
74 Light barrier
75 Data line
76 Transport roller
77 Adjustment device
81 Scoring knife
82 Adjustment drive
83 Data line
84 Plug
85 Carriage
86 Shaft
91 Scribing knife
93 Adjusting direction
100 Transport direction
130 Transport path
150 Loading position
200 Closing
300 Removing

1. An apparatus for processing predominantly rigid material sheets (30) or material webs, particularly for processing corrugated board sheets (30), comprising at least:
a transport path (30), along which the material sheets (30) are transported successively or the material web is transported through the device in a linear transport direction (100),
an electronic control (10), and
a frame (6) with at least two essentially vertical supports (11), which are arranged to both sides outside the transport path (130), an essentially horizontal crossbeam (12) that connects the at least two supports (11) and a linear guide (13) arranged on the horizontal crossbeam (12), wherein the guiding direction of said linear guide is oriented transverse to the transport direction (100),
comprising at least two processing devices (8, 9) that are mounted by means of the common linear guide (13), wherein each of these processing devices (8, 9) can be respectively moved transverse to the transport direction (100) separately by means of the linear guide (13) and comprises at least one tool (21, 81, 91) that acts upon the material sheet (30), and wherein the at least two processing devices (8, 9) are respectively connected to the control (10) of the apparatus with the aid of data transmission means (18, 19, 20, 22, 23).

2. The apparatus of claim 1, wherein at least two of the processing devices (8, 9) respectively have a separate adjustment device with a controllable adjustment drive (82), wherein the adjustment devices are respectively designed in such a way that they position the respective processing device (8, 9) transverse to the transport direction (100), and wherein each of the adjustment drives (82) is respectively connected to the control (10) of the apparatus with the aid of data transmission means (18, 19, 20, 23).

3. The apparatus of claim 2, comprising a gear rack (14) that is arranged essentially parallel to the at least one linear guide (13), wherein at least two adjustment devices of the processing devices (8, 9) respectively have a gear wheel (15) that is arranged on the assigned adjustment drive (82), and wherein these gear wheels (15) engage into the common gear rack (14).

4. The apparatus of claim 1, comprising at least one transport device (7) with a controllable drive (72), wherein the transport device (7) is designed for successively moving the material sheets (30) through the apparatus in the transport direction (100), with a data link (18, 19, 20, 22, 23) between the controllable drive (72) and the control (10) and with a detection device (74), which is directed at the transport path (130) and designed for detecting the point in time, at which a certain material sheet (30) reaches a predetermined position viewed in the transport direction (100) and/or for detecting the position of a certain material sheet (30) in the transport direction (100) at a predetermined point in time, wherein the detection device (74) is connected to the control (10) with the aid of data transmission means (18, 19, 20, 23, 75).

5. The apparatus of claim 1, comprising at least one cable (18) that serves as data transmission means of at least one of the at least two processing devices (8, 9) and has at least one separable and connectable plug connection (19) between the processing device (8, 9) and the control (10) of the apparatus.

6. The apparatus of claim 1, wherein at least one of the data transmission means between at least one processing device (8, 9) and the control (10) of the apparatus has at least one transmission unit (20) for electromagnetic waves.

7. The apparatus of claim 1, wherein the processing devices (8, 9) arranged on a common linear guide (13) have different tools (81, 91).

8. The apparatus of claim 1, comprising a loading position (150), wherein one or more processing devices (8, 9) can be removed and/or added in the loading position (150).

9. A converting machine for processing corrugated board sheets (30) or corrugated board webs with at least two apparatuses (1, 2, 3, 4) of claim 1, wherein the apparatuses (1, 2, 3, 4) are arranged successively in such a way that their respective transport paths form a common, essentially horizontal transport path (130) for the corrugated board sheets (30) through the converting machine, herein at least one of the apparatuses (1, 2, 3, 4) is arranged so as to be movable along the transport direction (100).

10. The converting machine of claim 8, comprising at least one linear guide that extends parallel to the transport direction (100) and comprises at least one rail (5), wherein the apparatus (2, 3, 4) that can be positioned along the transport path (130) or the apparatuses (2, 3, 4) that can be positioned along the transport path are respectively accommodated on the at least one rail (5).

11. The converting machine of claim 9, comprising at least
a dispensing device (21) with a processing device in the form of a first adjustment device, wherein the first adjustment device is designed for moving the dispensing device (21) into a first predetermined position transverse to the transport direction (100), and wherein the first adjustment device is connected to the control (10) of the converting machine with the aid of data transmission means (18, 19, 20), and
a second processing device (8, 9) that is arranged downstream of the at least one dispensing device (21) referred to the transport direction (100) and has a second adjustment device that is realized separately of the first adjustment device, wherein the second adjustment device is designed for moving the second processing device (8, 9) into a second predetermined position transverse to the transport direction (100), and wherein the second adjustment device is connected to the same control (10) of the converting machine with the aid of data transmission means (18, 19, 20).

12. A method for changing the configuration of a converting machine for processing corrugated board sheets (30) or corrugated board webs from a first configuration to a second configuration, wherein the converting machine has a transport path (130) with a linear transport direction for the corrugated board (30) and multiple apparatuses (1, 2, 3, 4) that are arranged successively without gaps in the transport direction (100), wherein each of the apparatuses (1, 2, 3, 4) comprises a frame (6) that encloses the transport path (130) and has at least one linear guide (13) extending transverse to the transport direction (100), multiple processing devices (8, 9) that are arranged on the linear guide (13) and can be separately moved along this linear guide, as well as a control (10) that is connected to the processing devices (8, 9) with the aid of data transmission means (18, 19, 20), and wherein the apparatuses respectively have identical interfaces and are arranged so as to be movable essentially parallel to the transport direction (100) by means of a common linear guide (5), with said method comprising at least the steps of:
moving at least a first apparatus (2, 3, 4) from a first position into a second position parallel to the transport direction (100), wherein the first apparatus (2, 3, 4) is in its first position arranged directly adjacent to another upstream and/or downstream apparatus (1, 2, 3, 4) and the first apparatus (2, 3, 4) is in its second position arranged at a distance from the same upstream and/or downstream apparatus (1, 2, 3, 4),
separating the data link between the control (10) and at least the processing devices (8, 9) arranged in the first apparatus (2, 3, 4),
removing (300) or adding an apparatus (2, 3, 4),
connecting the data links between the control (10) and the processing devices (8, 9) arranged in the converting machine,
closing (200) existing gaps between the apparatuses (1, 2, 3, 4) arranged within the converting machine by moving at least one of the apparatuses (1, 2, 3, 4) forming the gaps parallel to the transport direction, and
adjusting the control (10) in accordance with the second configuration of the converting machine.
